(19) United States
(12) Patent Application Publication
(10) Pub. No.: US 2018/0113607 A1
(43) Pub. Date: Apr. 26, 2018

(54) ELECTRONIC DEVICE AND DISPLAYING METHOD THEREOF

(71) Applicant: Samsung Electronics Co., Ltd., Gyeonggi-do (KR)

(72) Inventors: Kyung Tae KIM, Gyeonggi-do (KR); Soon Young LEE, Seoul (KR)

(73) Assignee: Samsung Electronics Co., Ltd.

(21) Appl. No.: 15/794,583

(22) Filed: Oct. 26, 2017

(30) Foreign Application Priority Data
Oct. 26, 2016 (KR) 10-2016-0140159

(51) Int. Cl. G06F 3/0488; G06F 3/041; G02B 27/22; H04N 13/00; H04N 13/02

(52) U.S. Cl. CPC G06F 3/04883; G06F 3/0416; H04N 13/0203; H04N 13/004; G02B 27/22

(57) ABSTRACT

An electronic device is disclosed which includes a display and a processor. The processor is configured to display a stereoscopic image including one or more objects in the display, if an event in which a user interface (UI) is displayed occurs, to identify an object, a display location of which overlaps a display location of the UI and a depth value of which is less than a depth value of the UI, from among the one or more objects, to change the depth value of at least one of the UI and the identified object, and to display the UI and the stereoscopic image in the display depending on the changed depth value.

### PRIORITY

This application claims priority under 35 U.S.C. § 119(a) to Korean Patent Applications filed in the Korean Intellectual Property Office on Oct. 26, 2016 and assigned Serial Number 10-2016-0140159, the contents of each of which are incorporated herein by reference.

### BACKGROUND

### 1. Field of the Disclosure

The present disclosure generally relates to a method for displaying contents or a user interface (UI) in a display.

### 2. Description of the Related Art

With the development of electronic technologies, various types of electronic products are being developed and distributed. In recent years, there has been extensively distributed an electronic device having a display such as a smartphone, a tablet PC, a TV, a monitor, a head mounted display (HMD), or the like.

The electronic device displays various pieces of information, for example, contents, a UI, and the like in a display. There has been recently developed a device providing the contents, the UI, or the like as a stereoscopic image by using a 3D image technology.

An A UI may be displayed together with contents upon displaying a stereoscopic image in a display. In the case of displaying a stereoscopic UI on the stereoscopic image, a difference in a depth value between the stereoscopic UI and objects included in the stereoscopic image may occur, and thus, a user may feel a difference or the user's eyes may be tired.

### SUMMARY

An aspect of the present disclosure provides an electronic device that displays an object such as a UI not included in a stereoscopic image in consideration of depth values of objects included in the stereoscopic image and the object not included in the stereoscopic image upon displaying a UI on the stereoscopic image, and a displaying method of the electronic device.

According to an aspect of the present disclosure, there may be resolved the difference or fatigue that a user feels when looking at a UI. In addition, even though a depth value of an object included in a stereoscopic image or a UI is changed, the user may recognize an object or a UI of a size that is the same as a size before the depth value is changed.

In accordance with an aspect of the present disclosure, an electronic device includes a display, and a processor is configured to display a stereoscopic image including one or more objects in the display, if an event in which a user interface (UI) is displayed occurs, identify an object, a display location of which overlaps a display location of the UI and a depth value of which is less than a depth value of the UI, from among the one or more objects, change the depth value of at least one of the UI and the identified object, and display the UI and the stereoscopic image in the display depending on the changed depth value.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device, according to embodiments of the present disclosure;

FIG. 2 illustrates a block diagram of an electronic device, according to embodiments of the present disclosure;

FIG. 3 illustrates a block diagram of a program module, according to embodiments of the present disclosure;

FIG. 4 is a block diagram illustrating a configuration of an electronic device, according to embodiments of the present disclosure;

FIGS. 5A to 5C illustrate a display screen, according to embodiments of the present disclosure;

FIGS. 6A to 6C illustrate an embodiment in which a depth value of a UI decreases;

FIGS. 7A to 7C illustrate an embodiment in which a depth value of an identified object increases;

FIGS. 8A to 8C illustrate an embodiment in which a depth value of a UI increases;

FIGS. 9A to 9C illustrate an embodiment in which a depth value of an identified object decreases; and

FIG. 10 is a flowchart illustrating a displaying method of an electronic device, according to embodiments of the present disclosure.

Throughout the drawings, it should be noted that like reference numbers are used to depict the same or similar elements, features, and structures.

### DETAILED DESCRIPTION OF EMBODIMENTS OF THE DISCLOSURE

Hereinafter, embodiments of the present disclosure may be described with reference to accompanying drawings. Accordingly, those of ordinary skill in the art will recognize that modifications, equivalents, and/or alternatives to the embodiments described herein can be variously made without departing from the scope and spirit of the present disclosure. In this disclosure, the expressions “have”, “may have”, “include” and “comprise”, or “may include” and “may comprise” used herein indicate the existence of corresponding features and elements such as numeric values, functions, operations, or components, but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element, such as a first element, is referred to as being “(operatively or communicatively) coupled with/to” or “connected to” another element, such as a second element, the first element may be directly coupled with/to or connected to the second element or an intervening element, such as a third element, may be present. In contrast, when, the first element is referred to as being “directly coupled with/to” or “directly connected to” the second element, it should be understood that there is no intervening third element present.

According to the situation, the expression “configured to” used in this disclosure may be interchangeably used with the expressions “suitable for”, “having the capacity to”, “designed to”, “adapted to”, “made to”, or “capable of”. The term “configured to” must not indicate only “specifically designed to” in hardware. Instead, the expression “a device configured to” may indicate that the device is “capable of” operating together with another device or other components. A “processor configured to (or set to) perform A, B, and C” may indicate a dedicated processor or embedded processor for performing a corresponding operation or a generic-purpose processor, such as a central processing unit (CPU) or an application processor (AP), which performs corresponding operations by executing one or more software programs which are stored in a memory device.

Terms used in this disclosure are used to describe specified embodiments and are not intended to limit the scope of the present disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal manner unless expressly so defined in this disclosure. In some cases, even if terms are terms which are defined in this disclosure, they are not to be interpreted to exclude embodiments of this disclosure.

An electronic device according to embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), motion picture experts group (MPEG-1 or MPEG-2) audio layer 3 (MP3) players, mobile medical devices, cameras, or wearable devices. The wearable device may include at least one of an accessory type, such as watches, rings, bracelets, anklets, necklaces, glasses, contact lens, or HMDs, a fabric or garment-integrated type, such as an electronic apparel, a body-attached type, such as a skin pad or tattoos, or a bio-implantable type, such as an implantable circuit.

According to embodiments of the present disclosure, the electronic device may be a home appliance. The home appliances may include at least one of televisions (TVs), digital versatile disc (DVD) players, audios, refrigerators, air conditioners, cleaners, ovens, microwave ovens, washing machines, air cleaners, set-top boxes, home automation control panels, security control panels, TV boxes, such as Samsung HomeSync™, Apple TV™, or Google TV™, game consoles, such as Xbox™ or PlayStation™, electronic dictionaries, electronic keys, camcorders, and electronic picture frames.

According to another embodiment, an electronic device may include at least one of various portable medical measurement devices including a blood glucose monitoring device, a heartbeat measuring device, a blood pressure measuring device, a body temperature measuring device, magnetic resonance angiography (MRA), magnetic resonance imaging (MRI), computed tomography (CT), scanners, and ultrasonic devices, navigation devices, global navigation satellite system (GNSS), event data recorders (EDRs), flight data recorders (FDRs), vehicle infotainment devices, electronic equipment for vessels, such as navigation systems and gyrocompasses, avionics, security devices, head units for vehicles, industrial or home robots, automatic teller machines (ATMs), points of sales (POS) devices, or an Internet of things device, such as light bulbs, various sensors, electric or gas meters, sprinkler devices, fire alarms, thermostats, street lamps, toasters, exercise equipment, hot water tanks, heaters, boilers.

According to an embodiment, the electronic device may include at least one of parts of furniture or buildings/structures, electronic boards, electronic signature receiving devices, projectors, or various measuring instruments including water meters, electricity meters, gas meters, or wave meters. The electronic device may be one of the above-described devices or a combination thereof and may be a flexible electronic device, but is not limited to the above-described electronic devices and may include other electronic devices and new electronic devices according to the development of new technologies.

Hereinafter, electronic devices according to embodiments of the present disclosure will be described with reference to the accompanying drawings. In this disclosure, the term “user” may refer to a person who uses an electronic device or may refer to an artificial intelligence electronic device that uses the electronic device.

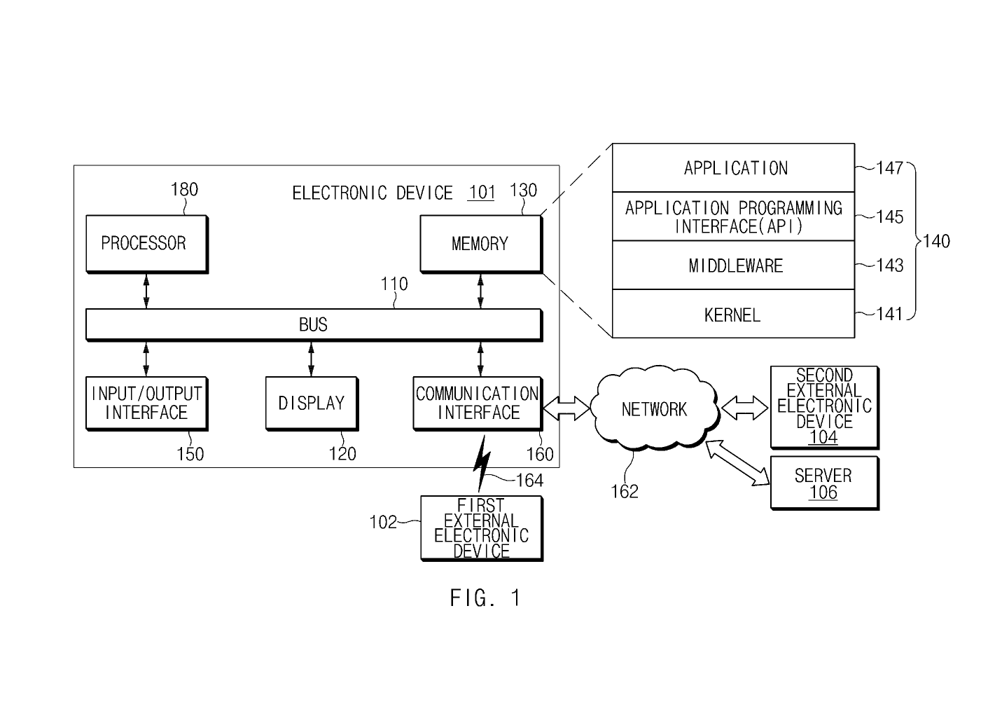

FIG. 1 illustrates an electronic device, according to embodiments of the present disclosure.

Referring to FIG. 1, according to embodiments of the present disclosure, an electronic device 101, 102, or 104, or a server 106 may be connected each other over a network 162 or short range communication 164. The electronic device 101 may include a bus 110, a processor 180, a memory 130, an input/output interface 150, a display 120, and a communication interface 160. The electronic device 101 may not include at least one of the above-described elements or may further include other element(s).

The bus 110 may interconnect the above-described elements 110 to 170 and may include a circuit for conveying communications, such as a control message and/or data among the above-described elements.

The processor 180 may include one or more of a CPU, an AP, or a communication processor (CP). The processor 180 may perform an arithmetic operation or data processing associated with control and/or communication of at least other elements of the electronic device 101.

The memory 130 may include a volatile and/or nonvolatile memory. For example, the memory 130 may store instructions or data associated with at least one other element(s) of the electronic device 101. According to an embodiment, the memory 130 may store software and/or a program 140. The program 140 may include, for example, a kernel 141, a middleware 143, an application programming interface (API) 145, and/or an application program (or application) 147. At least a part of the kernel 141, the middleware 143, or the API 145 may be referred to as an operating system (OS).

For example, the kernel 141 may control or manage system resources, such as the bus 110, the processor 180, and the memory 130 that are used to execute operations or functions of other programs, such as the middleware 143, the API 145, and the application program 147. Furthermore, the kernel 141 may provide an interface that allows the middleware 143, the API 145, or the application program 147 to access discrete elements of the electronic device 101 so as to control or manage system resources.

The middleware 143 may perform a mediation role such that the API 145 or the application program 147 communicates with the kernel 141 to exchange data. Furthermore, the middleware 143 may process task requests received from the application program 147 according to a priority. For example, the middleware 143 may assign the priority, which makes it possible to use a system resource, such as the bus 110, the processor 180, and the memory 130 of the electronic device 101, to at least one of the application programs 147. For example, the middleware 143 may process the one or more task requests according to the priority assigned to the at least one, which makes it possible to perform scheduling or load balancing on the one or more task requests.

The API 145 may be an interface through which the application program 147 controls a function provided by the kernel 141 or the middleware 143, and may include at least one interface or function, such as an instruction, for a file control, a window control, image processing, or a character control.

The input/output interface 150 transmits an instruction or data input from a user or another external device, to other element(s) of the electronic device 101. Furthermore, the input/output interface 150 may output an instruction or data, received from other element(s) of the electronic device 101, to a user or another external device.

The display 120 may include a liquid crystal display (LCD), a light-emitting diode (LED) display, an organic LED (OLED) display, a microelectromechanical systems (MEMS) display, or an electronic paper display. The display 120 may display, for example, various contents, such as a text, an image, a video, an icon, and a symbol, to a user. The display 120 may include a touch screen and may receive a touch, gesture, proximity, or hovering input using an electronic pen or a part of a user's body.

For example, the communication interface 160 may establish communication between the electronic device 101 and an external device, such as the first external electronic device 102, the second external electronic device 104, or the server 106. For example, the communication interface 160 may be connected to the network 162 by wireless communication or wired communication to communicate with the external device.

The wireless communication may include a cellular communication using at least one of, for example, long-term evolution (LTE), LTE advanced (LTE-A), code division multiple access (CDMA), wideband CDMA (WCDMA), universal mobile telecommunications system (UMTS), wireless broadband (WiBro), global system for mobile communications (GSM), or the like, as cellular communication protocol. According to an embodiment, the wireless communication may include wireless fidelity (Wi-Fi), Bluetooth, Bluetooth low energy (BLE), zigbee, near field communication (NFC), magnetic secure transmission (MST), radio frequency (RF), body area network (BAN), or a global navigation satellite system (GNSS).

The MST may generate a pulse in response to transmission data using an electromagnetic signal, and the pulse may generate a magnetic field signal. The electronic device 101 may transfer the magnetic field signal to a POS device, and the POS device may detect the magnetic field signal using an MST reader. The POS device may recover the data by converting the detected magnetic field signal to an electrical signal.

The GNSS may include at least one of a global positioning system (GPS), a global navigation satellite system (Glonass), a Beidou navigation satellite system (Beidou), or a European global satellite-based navigation system (Galileo) based on an available region or bandwidth. Hereinafter, in this disclosure, “GPS” and “GNSS” may be interchangeably used. The wired communication may include at least one of a universal serial bus (USB), a high definition multimedia interface (HDMI), a recommended standard-232 (RS-232), or a plain old telephone service (POTS). The network 162 may include at least one telecommunications network, for example, a computer network, such as LAN or WAN, an Internet, or a telephone network.

Each of the first and second external electronic devices 102 and 104 may be a device of which the type is different from or the same as that of the electronic device 101. The server 106 may include a group of one or more servers. According to embodiments of the present disclosure, all or a portion of operations that the electronic device 101 will perform may be executed by another or plural electronic devices, such as the first external electronic device 102, the second external electronic device 104 or the server 106. In the case where the electronic device 101 executes any function or service automatically or in response to a request, the electronic device 101 may not perform the function or the service internally, but alternatively or additionally, it may request at least a portion of a function associated with the electronic device 101 from another device, such as the external electronic device 102 or 104 or the server 106. The other electronic device may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

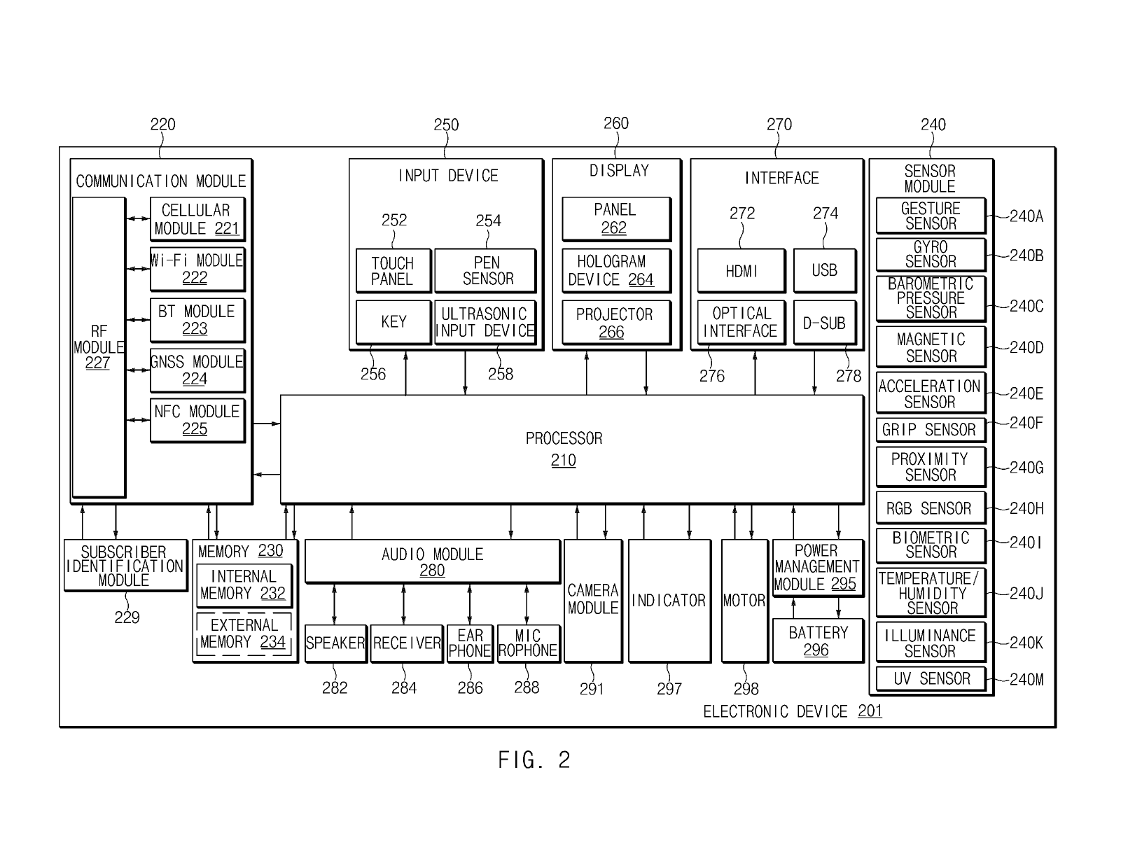

FIG. 2 illustrates a block diagram of an electronic device, according to embodiments of the present disclosure.

Referring to FIG. 2, an electronic device 201 may include, for example, all or a part of the electronic device 101 illustrated in FIG. 1. The electronic device 201 may include one or more processors, such as an AP 210, a communication module 220, a subscriber identification module (SIM) 229, a memory 230, a sensor module 240, an input device 250, a display 260, an interface 270, an audio module 280, a camera module 291, a power management module 295, a battery 296, an indicator 297, and a motor 298.

The processor 210 may drive, for example, an OS or an application to control a plurality of hardware or software elements connected to the processor 210 and may process and compute a variety of data. For example, the processor 210 may be implemented with a system on chip (SoC). According to an embodiment, the processor 210 may further include a graphic processing unit (GPU) and/or an image signal processor. The processor 210 may include at least a part, such as a cellular module 221, of elements illustrated in FIG. 2. The processor 210 may load an instruction or data, which is received from at least one of other elements, such as a nonvolatile memory, into a volatile memory and process the loaded instruction or data. The processor 210 may store a variety of data in the nonvolatile memory.

The communication module 220 may be configured the same as or similar to the communication interface 160 of FIG. 1. The communication module 220 may include the cellular module 221, a Wi-Fi module 222, a Bluetooth (BT) module 223, a GNSS module 224, such as a GPS module, a Glonass module, a Beidou module, or a Galileo module, a near field communication (NFC) module 225, and a radio frequency (RF) module 227.

The cellular module 221 may provide voice communication, video communication, a character service, or an Internet service over a communication network. According to an embodiment, the cellular module 221 may perform discrimination and authentication of the electronic device 201 within a communication network by using the SIM 229, such as a SIM card. The cellular module 221 may perform at least a portion of functions that the processor 210 provides. According to an embodiment, the cellular module 221 may include a CP.

Each of the Wi-Fi module 222, the BT module 223, the GNSS module 224, or the NFC module 225 may include a processor for processing data exchanged through a corresponding module, for example. According to an embodiment, at least a part, such as two or more, of the cellular module 221, the Wi-Fi module 222, the BT module 223, the GNSS module 224, or the NFC module 225 may be included within one integrated circuit (IC) or an IC package.

For example, the RF module 227 may transmit and receive a communication signal, such as an RF signal. For example, the RF module 227 may include a transceiver, a power amplifier module (PAM), a frequency filter, a low noise amplifier (LNA), or an antenna. According to another embodiment, at least one of the cellular module 221, the Wi-Fi module 222, the BT module 223, the GNSS module 224, or the NFC module 225 may transmit and receive an RF signal through a separate RF module.

The SIM 229 may include a card and/or embedded SIM that includes a subscriber identification module and may include unique identify information such as, integrated circuit card identifier (ICCID)) or subscriber information such as, integrated mobile subscriber identity (IMSI)).

The memory 230 may include an internal memory 232 or an external memory 234. For example, the internal memory 232 may include at least one of a volatile memory, such as a dynamic random access memory (DRAM), a static RAM (SRAM), a synchronous DRAM (SDRAM), a nonvolatile memory, such as a one-time programmable read only memory (OTPROM), a programmable ROM (PROM), an erasable and programmable ROM (EPROM), an electrically erasable and programmable ROM (EEPROM), a mask ROM, a flash ROM, a flash memory, such as a NAND flash memory or a NOR flash memory, a hard drive, or a solid state drive (SSD).

The external memory 234 may further include a flash drive such as compact flash (CF), secure digital (SD), micro secure digital (Micro-SD), mini secure digital (Mini-SD), extreme digital (xD), a multimedia card (MMC), a memory stick, and the like. The external memory 234 may be operatively and/or physically connected to the electronic device 201 through various interfaces.

A security module 236 may be a module that includes a storage space of which a security level is higher than that of the memory 230 and may be a circuit that guarantees safe data storage and a protected execution environment. The security module 236 may be implemented with a separate circuit and may include a separate processor. For example, the security module 236 may be in a smart chip or a secure digital (SD) card, which is removable, or may include an embedded secure element (eSE) embedded in a fixed chip of the electronic device 201. Furthermore, the security module 236 may operate based on an OS that is different from the OS of the electronic device 201. For example, the security module 236 may operate based on java card open platform (JCOP) OS.

The sensor module 240 may measure a physical quantity or may detect an operation state of the electronic device 201. The sensor module 240 may convert the measured or detected information to an electric signal. For example, the sensor module 240 may include at least one of a gesture sensor 240A, a gyro sensor 240B, a barometric pressure sensor 240C, a magnetic sensor 240D, an acceleration sensor 240E, a grip sensor 240F, the proximity sensor 240G, a color sensor 240H, such as red, green, blue (RGB) sensor, a biometric sensor 2401, a temperature/humidity sensor 240J, an illuminance sensor 240K, or an UV sensor 240M. Additionally, the sensor module 240 may further include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment, the electronic device 201 may further include a processor that is a part of the processor 210 or independent of the processor 210 and is configured to control the sensor module 240. The processor may control the sensor module 240 while the processor 210 remains in a sleep state.

The input device 250 may include a touch panel 252, a (digital) pen sensor 254, a key 256, or an ultrasonic input unit 258. For example, the touch panel 252 may use at least one of capacitive, resistive, infrared and ultrasonic detecting methods. Also, the touch panel 252 may further include a control circuit. The touch panel 252 may further include a tactile layer to provide a tactile reaction to a user.

The (digital) pen sensor 254 may be a part of a touch panel or may include an additional sheet for recognition. The key 256 may include a physical button, an optical key, or a keypad. The ultrasonic input device 258 may detect (or sense) an ultrasonic signal, which is generated from an input device, through a microphone 288 and may check data corresponding to the detected ultrasonic signal.

The display 260 may include a panel 262, a hologram device 264, or a projector 266. The panel 262 may be the same as or similar to the display 120 illustrated in FIG. 1. The panel 262 may be implemented to be flexible, transparent or wearable. The panel 262 and the touch panel 252 may be integrated into a single module. The hologram device 264 may display a stereoscopic image in a space using a light interference phenomenon. The projector 266 may project light onto a screen so as to display an image. For example, the screen may be arranged in the inside or the outside of the electronic device 201. According to an embodiment, the panel 262 may include a pressure sensor (or a force sensor) that measures the intensity of pressure corresponding to a user touch. The pressure sensor may be integrated with the touch panel 252 or may be implemented with one or more sensors independent of the touch panel 252. The display 260 may further include a control circuit for controlling the panel 262, the hologram device 264, or the projector 266.

The interface 270 may include an HDMI 272, a USB 274, an optical interface 276, or a D-subminiature (D-sub) 278. The interface 270 may be included in the communication interface 160 illustrated in FIG. 1. The interface 270 may include a mobile high definition link (MHL) interface, an SD card/multi-media card (MMC) interface, or an Infrared Data Association (IrDA) standard interface.

The audio module 280 may convert a sound and an electric signal in dual directions. At least a part of the audio module 280 may be included in the input/output interface 150 illustrated in FIG. 1. The audio module 280 may process sound information that is input or output through a speaker 282, a receiver 284, an earphone 286, or the microphone 288.

For example, the camera module 291 may shoot a still image or a video. According to an embodiment, the camera module 291 may include at least one or more image sensors, such as a front sensor or a rear sensor, a lens, an image signal processor (ISP), or a flash, such as an LED or a xenon lamp.

The power management module 295 may manage power of the electronic device 201. According to an embodiment, a power management integrated circuit (PMIC), a charger IC, or a battery gauge may be included in the power management module 295. The PMIC may have a wired charging method and/or a wireless charging method. The wireless charging method may include a magnetic resonance method, a magnetic induction method or an electromagnetic method and may further include an additional circuit a coil loop, a resonant circuit, or a rectifier. The battery gauge may measure a remaining capacity of the battery 296 and a voltage, current or temperature thereof while the battery is charged. The battery 296 may include a rechargeable battery and/or a solar battery.

The indicator 297 may display a specific state of the electronic device 201 or a part thereof, such as the processor 210, such as a booting state, a message state, or a charging state. The motor 298 may convert an electrical signal into a mechanical vibration and may generate the following effects: vibration, haptic, and the like. A processing device, such as a GPU, for supporting a mobile TV may be included in the electronic device 201. The processing device for supporting the mobile TV may process media data according to the standards of digital multimedia broadcasting (DMB), digital video broadcasting (DVB), mediaFlo™, etc.

Each of the above-mentioned elements of the electronic device according to embodiments of the present disclosure of the present disclosure may be configured with one or more components, and the names of the elements may be changed according to the type of the electronic device. The electronic device may include at least one of the above-mentioned elements, and some elements may be omitted or other additional elements may be added. Furthermore, some of the elements of the electronic device may be combined with each other so as to form one entity, so that the functions of the elements may be performed in the same manner as before the combination.

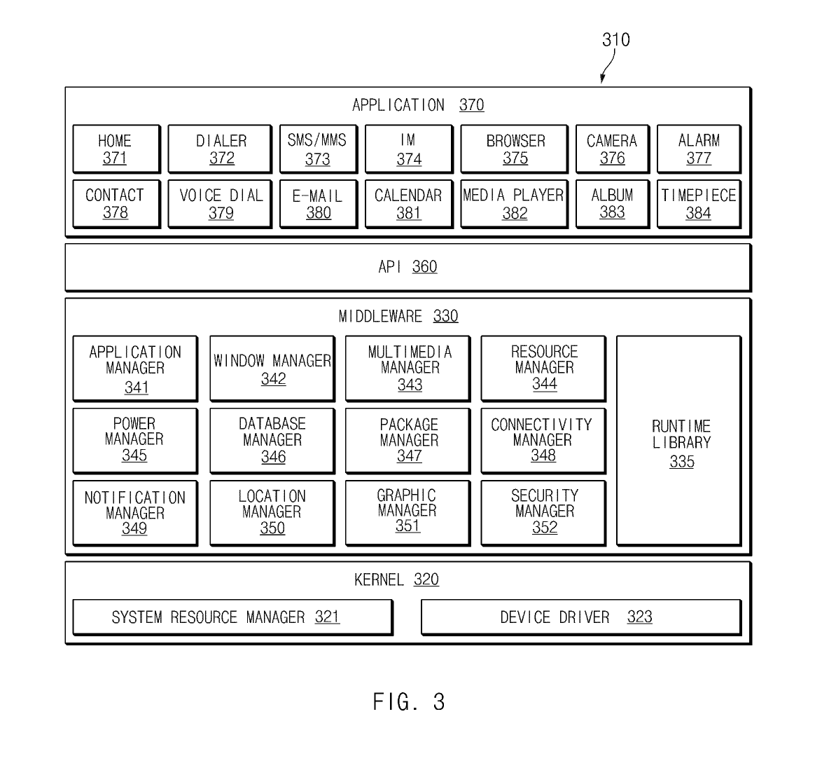

FIG. 3 illustrates a block diagram of a program module, according to embodiments of the present disclosure.

According to an embodiment, a program module 310 may include an OS to control resources associated with an electronic device 101, and/or diverse applications 147 driven on the OS. The OS may be an Android, iOS, Windows, Symbian, Tizen, or Bada.

The program module 310 may include a kernel 320, a middleware 330, an API 360, and/or an application 370. At least a portion of the program module 310 may be preloaded on an electronic device or may be downloadable from an external electronic device 102, 104, or the server 106.

The kernel 320 may include a system resource manager 321 or a device driver 323. The system resource manager 321 may perform control, allocation, or retrieval of system resources. According to an embodiment, the system resource manager 321 may include a process managing unit, a memory managing unit, or a file system managing unit. The device driver 323 may include a display driver, a camera driver, a Bluetooth driver, a shared memory driver, a USB driver, a keypad driver, a Wi-Fi driver, an audio driver, or an inter-process communication (IPC) driver.

The middleware 330 may provide a function that the application 370 needs in common, or may provide diverse functions to the application 370 through the API 360 to allow the application 370 to efficiently use limited system resources of the electronic device. According to an embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module that is used by a compiler to add a new function through a programming language while the application 370 is being executed. The runtime library 335 may perform input/output management, memory management, or capacities about arithmetic functions.

The application manager 341 may manage a life cycle of at least one application of the application 370. The window manager 342 may manage a graphic user interface (GUI) resource that is used in a screen. The multimedia manager 343 may identify a format necessary for playing diverse media files, and may perform encoding or decoding of media files by using a codec suitable for the format. The resource manager 344 may manage resources such as a storage space, memory, or source code of at least one application of the application 370.

The power manager 345 may operate with a basic input/output system (BIOS) to manage a battery or power, and may provide power information for an operation of an electronic device. The database manager 346 may generate, search for, or modify database that is to be used in at least one application of the application 370. The package manager 347 may install or update an application that is distributed in the form of package file.

The connectivity manager 348 may manage wireless connection such as Wi-Fi or Bluetooth. The notification manager 349 may display or notify an event such as arrival message, appointment, or proximity notification in a mode that does not disturb a user. The location manager 350 may manage location information about an electronic device. The graphic manager 351 may manage a graphic effect that is provided to a user, or manage a user interface relevant thereto. The security manager 352 may provide a general security function necessary for system security, user authentication, or the like. According to an embodiment, in the case where electronic device 101 includes a telephony function, the middleware 330 may further include a telephony manager for managing a voice or video call function of the electronic device.

The middleware 330 may include a middleware module that combines diverse functions of the above-described elements. The middleware 330 may provide a module specialized to each OS kind to provide differentiated functions. Additionally, the middleware 330 may dynamically remove a part of the preexisting elements or may add new elements thereto.

The API 360 may be a set of programming functions and may be provided with a configuration that is variable depending on an OS. For example, in the case where an OS is Android or iOS, it may provide one API set per platform. In the case where an OS is Tizen, it may provide two or more API sets per platform.

The application 370 may include one or more applications capable of providing functions for a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, and a timepiece 384, offering health care, such as measuring an exercise quantity, or blood sugar, or environment information, such as information of barometric pressure, humidity, or temperature.

According to an embodiment, the application 370 may include an information exchanging application to support information exchange between the electronic device 101 and an external electronic device 102, or 104. The information exchanging application may include a notification relay application for transmitting specific information to an external electronic device or a device management application for managing the external electronic device.

For example, the notification relay application may include a function of transmitting notification information, which arise from other applications, such as applications for SMS/MMS, e-mail, health care, or environmental information, to an external electronic device. Additionally, the information exchanging application may receive notification information from an external electronic device and provide the notification information to a user.

The device management application may manage, install, delete, or update at least one function, such as turn-on/turn-off of an external electronic device itself (or a part of elements) or adjustment of brightness (or resolution) of a display) of the first external electronic device 102 or the second external electronic device 104 which communicates with the electronic device, an application running in the external electronic device, or a service, such as a call service or a message service, provided from the external electronic device.

According to an embodiment, the application 370 may include a health care application of a mobile medical device that is assigned in accordance with an attribute of an external electronic device. The application 370 may include an application that is received from an external electronic device. The application 370 may include a preloaded application or a third party application that is downloadable from a server. The names of elements of the program module 310 may be modifiable depending on kinds of operating systems.

According to embodiments of the present disclosure, at least a portion of the program module 310 may be implemented by software, firmware, hardware, or a combination of two or more thereof. At least a portion of the program module 310 may be implemented or executed by the processor 210. At least a portion of the program module 310 may include modules, programs, routines, sets of instructions, or processes for performing one or more functions.

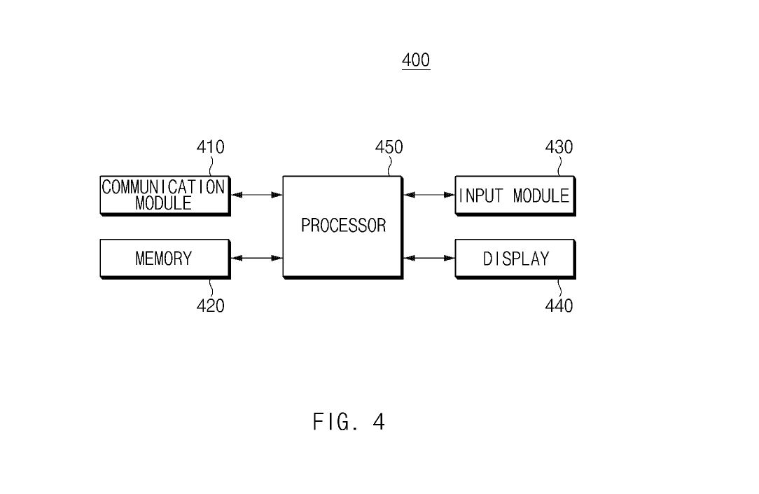

FIG. 4 is a block diagram illustrating a configuration of an electronic device, according to embodiments of the present disclosure.

Referring to FIG. 4, an electronic device 400 may include a communication module 410 (or a communication circuit), a memory 420, an input module 430 (or an input device), a display 440, and a processor 450. The electronic device 400 may be a device including a display, such as an HMD, a smartphone, a tablet PC, a TV, a monitor, or the like. According to an embodiment, a part of elements illustrated in FIG. 1 may be omitted.

According to an embodiment, the communication module 410 may communicate with an external electronic device. The communication module 410 may receive contents from the external electronic device. For example, the external electronic device may be a source device that is capable of providing the contents to the electronic device 400 after being connected with the electronic device 400, for example, a contents provider server, a smartphone, a tablet PC, a set-top box, a game console, a desktop PC, or the like, by wire or wirelessly. The contents may include a stereoscopic image and the contents may include a left-eye image and a right-eye image. The contents may also include the left-eye image (or the right-eye image) and a depth map (or a depth image), and the contents may include the left-eye image, the right-eye image, and the depth map.

According to an embodiment, the memory 420 may store the contents. For example, the memory 420 may store the contents received via the communication module 410. The memory 420 may store the UI. For example, the UI may include at least one of a shape, a character, an icon, a text, or a symbol. The UI may be a stereoscopic UI. For example, the UI may include a left-eye UI to be displayed in the left-eye image and a right-eye UI to be displayed in the right-eye image. The memory 420 may store the display location of the UI on the display 440. For example, the memory 420 may map the UI to the display location of the UI and may store the mapping information. The memory 420 may map the UI to depth information (or disparity information) of the UI and may store the mapping information.

According to an embodiment, the input module 430 may receive a user input. For example, the input module 430 may receive the user input for displaying the UI.

In an embodiment, the input module 430 may include a touch sensor panel that senses a touch manipulation of a user, a pressure sensor panel, or a pen sensor panel that senses a pen manipulation of a user. The input module 430 may include a button, jog & shuttle, a motion recognition sensor, or a voice recognition sensor. In the case where the electronic device 101 is an HMD, the input module 430 may include a motion detection sensor, such as a gyro sensor or an acceleration sensor, which senses the motion of the user's head.

According to an embodiment, the display 440 may display the contents including the stereoscopic image. The display 440 may display the contents that is received from an external electronic device via the communication module 410 or stored in the memory 420. The display 440 may display the UI. The display 440 may display the UI in three dimensions (3D).

According to an embodiment, after being embedded in the electronic device 400 or being electrically connected with the electronic device 400, the display 440 may be positioned outside the electronic device 400. The input module 430 and the display 440 may be implemented with a touch screen that is capable of displaying and sensing the touch input at the same time. In the touch screen, the touch sensor panel may be disposed on the display panel.

According to an embodiment, the processor 450 may control overall operations of the electronic device 400. For example, the processor 450 may display the UI in the display 440 by controlling each of the communication module 410, the memory 420, the input module 430, and the display 440.

According to an embodiment, the electronic device 400 may include the at least one processor 450. For example, the electronic device 400 may include a plurality of the processors 450 which execute at least one function. The processor 450 may be implemented with an SoC that includes a CPU, a GPU, and a memory.

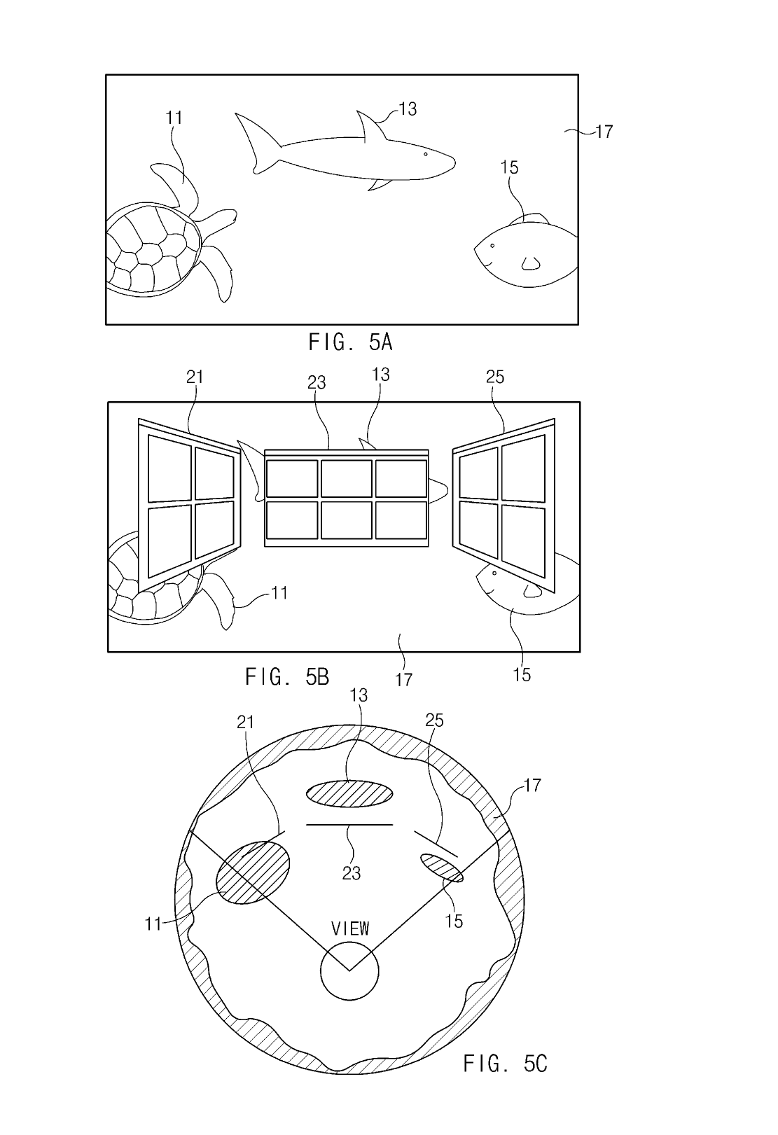

FIGS. 5A to 5C illustrate a display screen, according to embodiments of the present disclosure.

Specifically, FIG. 5A illustrates a screen in which a stereoscopic image displayed in a display is shown in a user's eyes, FIG. 5B illustrates a UI displayed on an image of FIG. 5A, and FIG. 5C is a view illustrating depths of a UI and an object included in the stereoscopic image.

According to an embodiment, the processor 450 may display contents including the stereoscopic image in the display 440. For example, the processor 450 may display a left-eye image in a partial area of the display 440 and may display a right-eye image in another partial area of the display 440. For another example, the processor 450 may alternately display the left-eye image and the right-eye image in the display 440 at a specified cycle or may display the left-eye image and the right-eye image so as to be alternately disposed within one image frame.

According to an embodiment, the stereoscopic image may include at least one object. For example, referring to FIG. 5A, the stereoscopic image may include a first object 11, a second object 13, a third object 15, and a fourth object 17. For example, the fourth object 17 may be a background image.

According to an embodiment, if a UI display event occurs, the processor 450 may display at least one UI corresponding to the event in the display 440. For example, referring to FIG. 5B, the processor 450 may display a first UI 21, a second UI 23, and a third UI 25 in the display 440. For example, if receiving a user input for displaying the UI via the input module 430, the processor 450 may display the UI in the display 440. For another example, if the play of the contents ends, the processor 450 may display the UI in the display 440. For another example, if a message or an e-mail is received via the communication module 410, the processor 450 may display the UI. The processor 450 may display the UI in the display 440 in 3D.

According to an embodiment, the processor 450 may display the contents and the UI by using a plurality of layers. For example, the plurality of layers may include at least one contents layer including an object included in the contents and at least one UI layer including a UI. After being overlapped depending on a specified order, the plurality of layers may be displayed in the display 440. The UI layer may be positioned on the contents layer. For example, in FIG. 5B, the plurality of UIs 21, 23, and 25 may be displayed on (or in front of) the plurality of objects 11, 13, 15, and 17. For example, the plurality of UIs 21, 23, and 25 may be displayed to be closer to user's eyes than the plurality of objects 11, 13, 15, and 17.

According to an embodiment, the processor 450 may respectively compare the display location and the depth value of the UI with the display location and the depth value of at least one object included in the stereoscopic image before displaying the UI in the display 440. The processor 450 may identify an object, the display location of which overlaps the display location of the UI and the depth value of which is less than the depth value of the UI, from among one or more objects included in the stereoscopic image. For example, the processor 450 may identify an object, the display location of which overlaps the display location of the UI, from among the objects included in the stereoscopic image and may determine whether the depth value of the object, the display location of which overlaps the display location of the UI, is less than the depth value of the UI. For example, referring to FIG. 5B, at least part of display locations of the first object 11 and the first UI 21 may be overlapped. At least part of display locations of the second object 13 and the second UI 23 may be overlapped. At least part of display locations of the third object 15 and the third UI 25 may be overlapped. Referring to FIG. 5C, at least part of the first object 11 may have a depth value less than the depth value of the first UI 21, and at least part of the third object 15 may have a depth value less than the depth value of the third UI 25. As such, the processor 450 may identify each of the first object 11 and the third object 15 as an object, the display location of which overlaps the display location of the UI and which is closer to a view point than the UI.

According to an embodiment, if the depth value of at least part of the object is less than the depth value of the UI, the processor 450 may determine that the depth value of the object is less than that of the UI. For example, referring to FIG. 5C, a part of the first object 11 may have a depth value greater than that of the first UI 21. The remaining parts of the first object 11 may have a depth value less than that of the first UI 21. Accordingly, the processor 450 may determine that the first object 11 has a depth value less than that of the first UI 21.

According to an embodiment, the processor 450 may determine whether depth values of the UI and at least one object included in the stereoscopic image are overlapped with each other, by using the depth map of the stereoscopic image. If the depth map is not included in the stereoscopic image, such as if the stereoscopic image includes only both the left-eye image and the right-eye image, the processor 450 may generate a depth map by using the stereoscopic image. For example, the processor 450 may generate a disparity map (or a disparity image) including disparity information of an object (or a pixel) included in both the left-eye image and the right-eye image, and may convert the generated disparity map into the depth map. The processor 450 may determine whether depth values of the UI and at least one object included in the stereoscopic image are overlapped with each other, by using the depth map generated from the stereoscopic image.

Referring to FIGS. 5B and 5C, even though the first UI 21 and the third UI 25 are respectively displayed in front of the first object 11 and the third object 15, the first and third UIs 21 and 25 may respectively have depth values greater than depth values of the first object 11 and the third object 15. For example, the mismatch between an overlap order (or a depth order), which is recognized by a user, and a depth value may occur in both the first UI 21 and the first object 11 or in both the third UI 25 and the third object 15. As such, when the user watches the first UI 21 or the third UI 25, the user may feel a difference or fatigue by the first object 11 or the third object 15 displayed at a periphery of the first UI 21 or the third UI 25.

According to embodiments of the present disclosure, the processor 450 may change the depth value of at least one of the UI and an object (the identified object), the display location of which overlaps the display location of the UI and the depth value of which is less than the depth value of the UI. For example, the processor 450 may change the disparity of at least one of the UI included in both the left-eye image and the right-eye image and the identified object. As the disparity between the left-eye image and the right-eye image becomes greater, the depth value may become less. As the disparity between the left-eye image and the right-eye image becomes less, the depth value may become greater.

According to an embodiment, when changing the depth value of the UI or the identified object, the processor 450 may change the size of the UI or the identified object in 3D space. The processor 450 may change the size of the UI or the identified object based on the depth value of the UI or the identified object. For example, if the depth values of the UI or the identified object become less, the processor 450 may decrease the size of the UI or the identified object. For another example, if the depth values of the UI or the identified object become greater, the processor 450 may increase the size of the UI or the identified object.

According to an embodiment, the processor 450 may change the size of the UI or the identified object depending on Equation (1) as follows:

$${x}^{′} = x \times \frac{{z}^{′}}{z} \qquad ( 1 )$$

In Equation (1), x′ denotes the size, such as a width, a height, or a thickness of the UI or the identified object after being changed, x denotes the size of the UI or the identified object before being changed, z′ denotes the depth value of the UI or the identified object after being changed, and z denotes the depth value of the UI or the identified object before being changed. The size x′ of the UI after being changed may be proportional to the depth value of the UI 21.

According to an embodiment, if at least one of the depth values, the overlap order (or the depth order), and the sizes of the UI and the identified object are changed, the processor 450 may display the UI and the stereoscopic image in the display 440 depending on the changed depth values, overlap order, and sizes. For example, the processor 450 may reflect the change in the depth values, the overlap order, and the sizes of the UI and the identified object to render the left-eye image and the right-eye image.

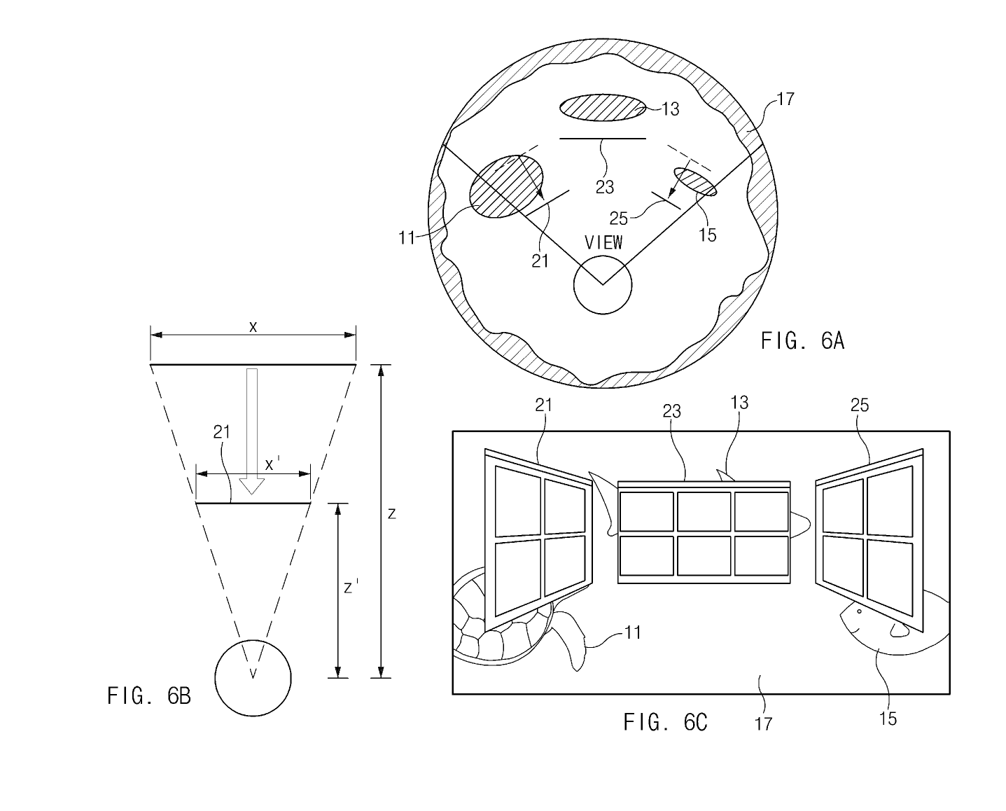

FIGS. 6A to 6C illustrates an embodiment in which a depth value of a UI decreases.

According to an embodiment, the processor 450 may decrease the depth value of the UI so as to be less than the depth value of the identified object. For example, referring to FIG. 6A, the processor 450 may decrease the depth value of the first UI 21 such that the first UI 21 has a depth value less than that of the first object 11. For another example, the processor 450 may decrease the depth value of the third UI 25 such that the third UI 25 has a depth value less than the depth value of the third object 15.

According to an embodiment, if the depth value of the UI is changed, the processor 450 may change the size of the UI in 3D space so as to correspond to the changed depth value. For example, referring to FIG. 6B, if the depth value of the first UI 21 decreases from z to z′, the processor 450 may decrease the size of the first UI 21 from x to x′ so as to be proportional to the decreased depth value. As such, even though the depth value of the UI is changed, the UI may be displayed to a user at an original size.

Referring to FIG. 6C, the first UI 21 and the third UI 25 may be displayed in front of the first object 11 and the third object 15, respectively. The first UI 21 and the third UI 25 may have depth values less than those of the first object 11 and the third object 15, respectively. For example, as the depth values of the first UI 21 and the third UI 25 are changed, the mismatch between an overlap order (or a depth order), which is recognized by a user, and a depth value may be resolved in both the first UI 21 and the first object 11 or in both the third UI 25 and the third object 15. As such, there may be resolved the difference or fatigue that a user feels when a user looks at the first UI 21 or the third UI 25.

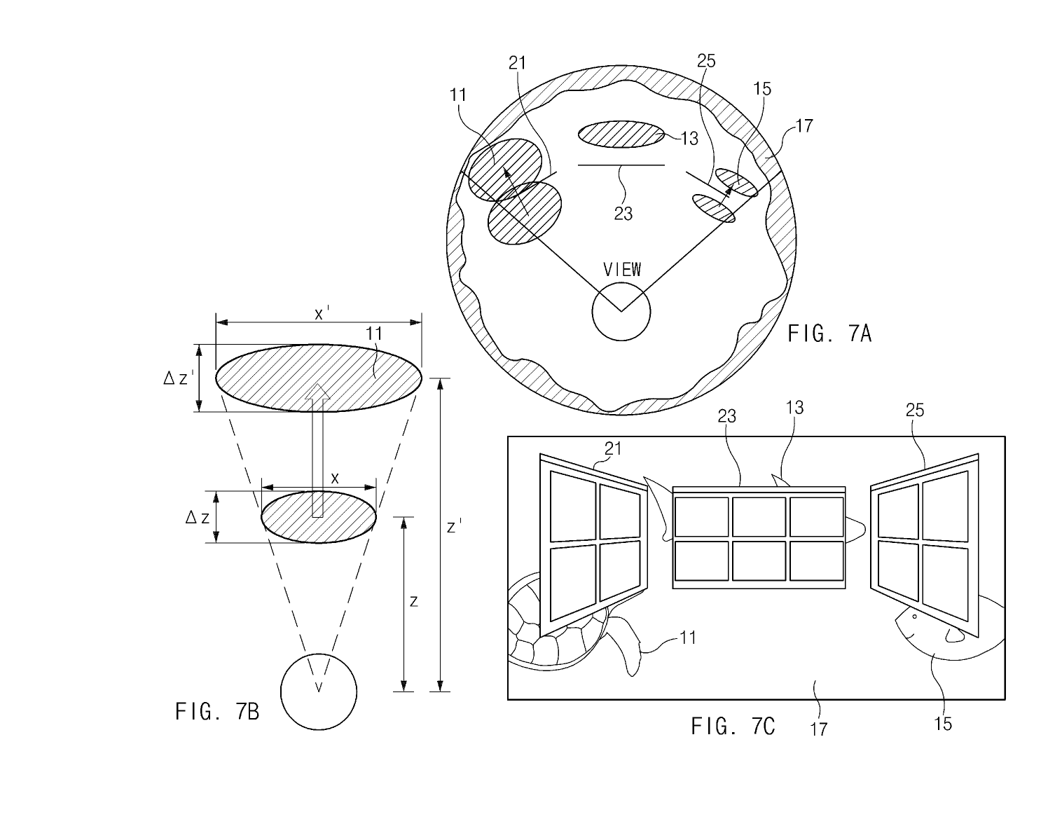

FIGS. 7A to 7C illustrate an embodiment in which a depth value of an identified object increases.

According to an embodiment, the processor 450 may increase the depth value of the identified object such that the depth value of a UI is less than the depth value of the identified object. For example, referring to FIG. 7A, the processor 450 may increase the depth value of the first object 11 such that the first UI 21 has a depth value less than that of the first object 11. For another example, the processor 450 may increase the depth value of the third object 15 such that the third UI 25 has a depth value less than the depth value of the third object 15.

According to an embodiment, if the depth value of the identified object is changed, the processor 450 may change the size of the identified object in 3D space so as to correspond to the changed depth value. For example, referring to FIG. 7B, if the depth value of the first object 11 increases from z to z′, the processor 450 may increase the size of the first object 11 from x to x′ so as to be proportional to the increased depth value. For another example, if the depth value of the first object 11 increases from z to z′, the processor 450 may increase the thickness of the first object 11 from Δz to Δz′ so as to be proportional to the increased depth value.

Referring to FIG. 7C, the first UI 21 and the third UI 25 may be displayed in front of the first object 11 and the third object 15, respectively. The first UI 21 and the third UI 25 may have depth values less than those of the first object 11 and the third object 15, respectively. For example, as the depth values of the first object 11 and the third object 15 are changed, the mismatch between an overlap order (or a depth order), which is recognized by a user, and a depth value may be resolved in both the first UI 21 and the first object 11 or in both the third UI 25 and the third object 15. As such, there may be resolved the difference or fatigue that a user feels when a user looks at the first UI 21 or the third UI 25.

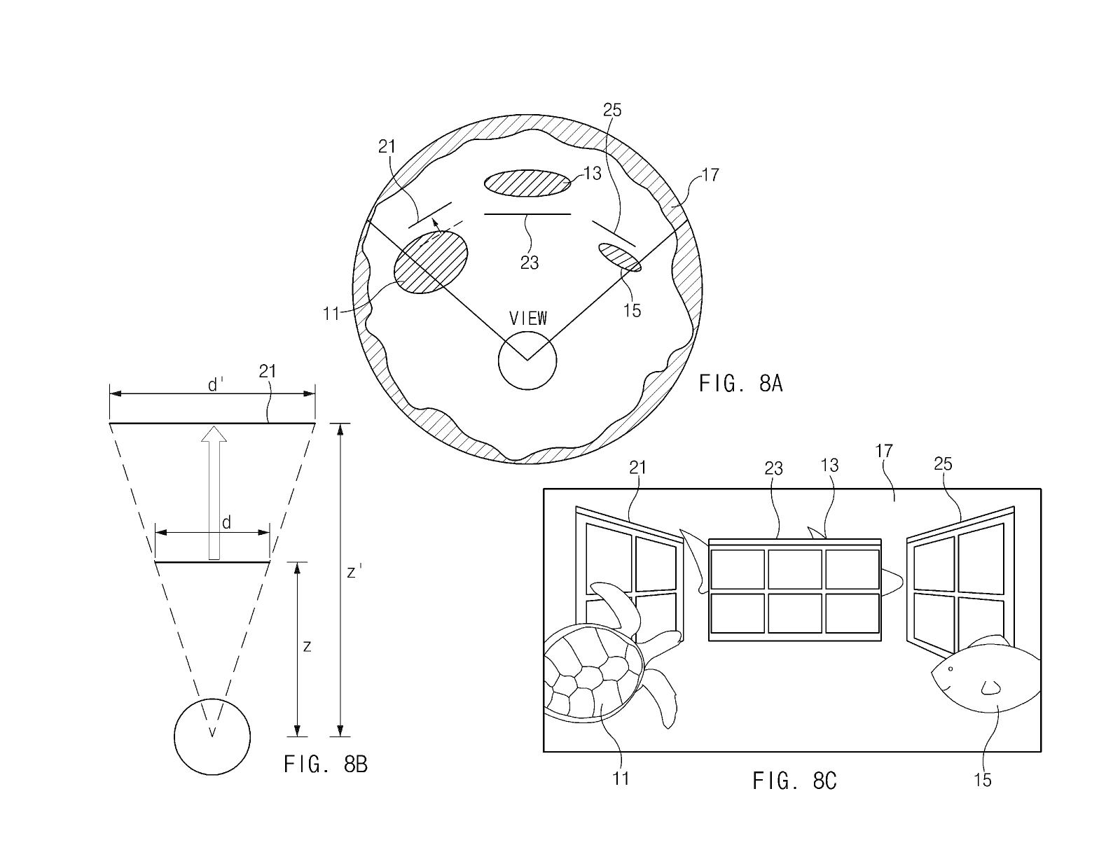

FIGS. 8A to 8C illustrates an embodiment in which a depth value of a UI increases.

According to an embodiment, the processor 450 may increase the depth value of the UI such that the depth value of the UI is greater than the depth value of the identified object. For example, referring to FIG. 8A, the processor 450 may increase the depth value of the first UI 21 such that the first UI 21 has a depth value greater than that of the first object 11.

According to an embodiment, if the depth value of the UI is changed, the processor 450 may change the size of the UI in 3D space so as to correspond to the changed depth value. For example, referring to FIG. 8B, if the depth value of the first UI 21 increases from z to z′, the processor 450 may increase the size of the first UI 21 from x to x′ so as to be proportional to the increased depth value. As such, even though the depth value of the UI is changed, the UI may be displayed to a user at an original size.

According to an embodiment, the processor 450 may change an overlap order of a layer including the UI and a layer including the identified object so as to correspond to the changed depth value. For example, the processor 450 may change an overlap order of a first layer including the first object 11 and a second layer including the first UI 21. For another example, the processor 450 may change an overlap order of a third layer including the third object 15 and a fourth layer including the third UI 25. As such, the first object 11 may be displayed on the first UI 21, and the third object 15 may be displayed on the third UI 25.

Referring to FIG. 8C, the first UI 21 and the third UI 25 may be displayed behind the first object 11 and the third object 15, respectively. The first UI 21 and the third UI 25 may have depth values greater than those of the first object 11 and the third object 15, respectively. As the depth value of the first UI 21 is changed and the overlap order of the first UI 21 and the third UI 25 are changed, the mismatch between an overlap order (or a depth order), which is recognized by a user, and a depth value may be resolved in both the first UI 21 and the first object 11 or in both the third UI 25 and the third object 15. As such, there may be resolved the difference or fatigue that a user feels when a user looks at the first UI 21 or the third UI 25.

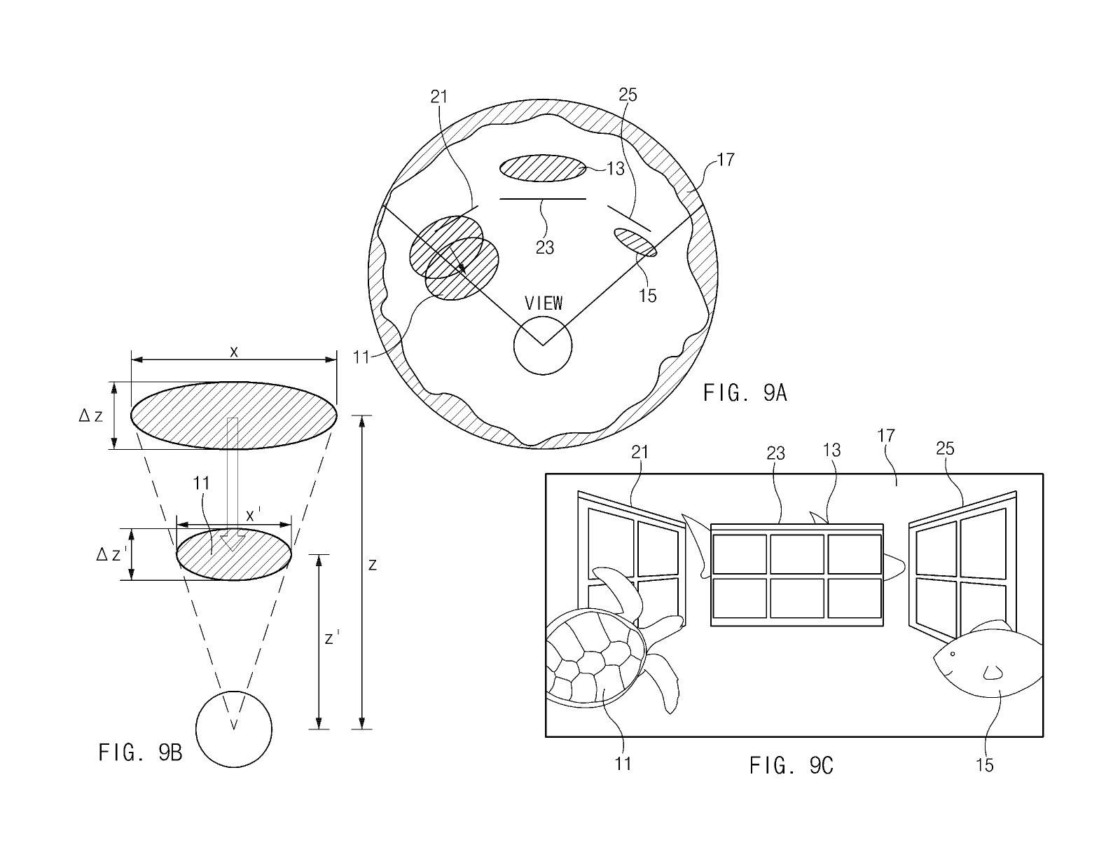

FIGS. 9A to 9C illustrate an embodiment in which a depth value of an identified object decreases.

According to an embodiment, the processor 450 may decrease the depth value of the identified object such that the depth value of a UI is greater than the depth value of the identified object. For example, referring to FIG. 9A, the processor 450 may decrease the depth value of the first object 11 such that the first UI 21 has a depth value greater than that of the first object 11.

According to an embodiment, if the depth value of the identified object is changed, the processor 450 may change the size of the identified object in 3D space so as to correspond to the changed depth value. For example, referring to FIG. 9B, if the depth value of the first object 11 decreases from z to z′, the processor 450 may decrease the size of the first object 11 from x to x′ so as to be proportional to the decreased depth value. For another example, if the depth value of the first object 11 decreases from z to z′, the processor 450 may decrease the thickness of the first object 11 from Az to Az′ so as to be proportional to the decreased depth value.

According to an embodiment, the processor 450 may change an overlap order of a layer including the UI and a layer including the identified object so as to correspond to the changed depth value. For example, the processor 450 may change an overlap order of a first layer including the first object 11 and a second layer including the first UI 21. For another example, the processor 450 may change an overlap order of a third layer including the third object 15 and a fourth layer including the third UI 25. As such, the first object 11 may be displayed on the first UI 21, and the third object 15 may be displayed on the third UI 25.

Referring to FIG. 9C, the first UI 21 and the third UI 25 may be displayed behind the first object 11 and the third object 15, respectively. The first UI 21 and the third UI 25 may have depth values greater than those of the first object 11 and the third object 15, respectively. As the depth value of the first UI 21 is changed and the overlap order of the first UI 21 and the third UI 25 are changed, the mismatch between an overlap order (or a depth order), which is recognized by a user, and a depth value may be resolved in both the first UI 21 and the first object 11 or in both the third UI 25 and the third object 15. As such, there may be resolved the difference or fatigue that a user feels when a user looks at the first UI 21 or the third UI 25.

According to an embodiment, the processor 450 may simultaneously change the depth values of the UI and the identified object. For example, the processor 450 may decrease the depth value of the UI and, at the same time, may increase the depth value of the identified object. For example, the processor 450 may increase the depth value of the UI and, at the same time, may decrease the depth value of the identified object. For another example, the processor 450 may decrease the depth value of the UI by a first value and, at the same time, may decrease the depth value of the identified object by a second value less than the first value. For another example, the processor 450 may increase the depth value of the UI by a third value and, at the same time, may increase the depth value of the identified object by a fourth value greater than the third value.

In the case where the processor 450 decreases the depth value of the UI or the identified object, the UI or the identified object may be displayed too close to a user. In the case where the UI or the identified object is displayed too close to the user, it may interfere with the user. The processor 450 may determine whether the depth value of the UI or the identified object is less than a specified depth value. According to an embodiment, if the depth value of the UI or the identified object is less than a specified depth value, the processor 450 may display the stereoscopic image and the UI as a 2-dimensional (2D) image.

According to an embodiment, the display location or the depth value of at least one object included in a stereoscopic image or a UI may be changed over time. For example, the stereoscopic image displayed on the display 440 may be changed depending on the movement of the user's head mounting a HMD. For another example, depending on a user input, a new UI may be displayed in the display 440 or the location or the depth value of the UI may be changed. If the display location or the depth value of at least one objects or the UI displayed in the display 440 is changed, the processor 450 may identify an object, the display location of which overlaps the display location of the UI and the depth value of which is less than the depth value of the UI, from among one or more objects included in the stereoscopic image. The processor 450 may change a depth value of at least one of the UI and the identified object depending on the changed display location.

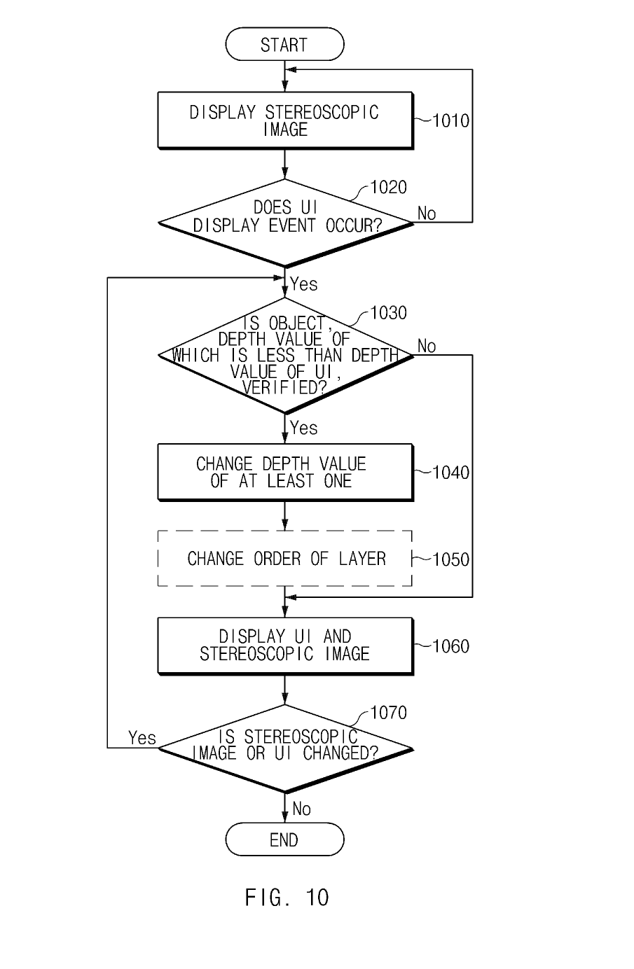

FIG. 10 is a flowchart illustrating a displaying method of an electronic device, according to embodiments of the present disclosure.

The method of FIG. 10 may include steps that the above-described electronic device 400 processes. Detailed descriptions about the electronic device described with reference to FIGS. 1 to 9C may be applied to the flowchart shown in FIG. 10.

According to an embodiment, in step 1010, the electronic device may display a stereoscopic image (or contents) in a display. For example, the electronic device may display a left-eye image in a partial area of the display and may display a right-eye image in another partial area of the display. For another example, the electronic device may alternately display the left-eye image and the right-eye image in the display at a specified cycle or may display the left-eye image and the right-eye image so as to be alternately disposed within one image frame.

According to an embodiment, in step 1020, the electronic device may determine whether a UI display event occurs. For example, the electronic device may determine whether a user input for displaying the UI is received through the input module 430 or whether the play of contents ends. For another example, the electronic device may determine whether a message or an e-mail is received.

According to an embodiment, the electronic device may display the stereoscopic image and the UI by using a plurality of layers. For example, the plurality of layers may include at least one contents layer including an object included in the stereoscopic image and at least one UI layer including a UI.

According to an embodiment, if the UI display event occurs, in step 1030, the electronic device may identify an object, the display location of which overlaps the display location of the UI and the depth value of which is less than the depth value of the UI. The electronic device may compare the display location and the depth value of the UI with the display location and the depth value of at least one object included in the stereoscopic image before displaying the UI in the display. If the depth value of at least part of the object is less than the depth value of the UI, the electronic device may determine that the depth value of the object is less than that of the UI.

According to an embodiment, the electronic device may determine whether depth values of the UI and at least one object included in the stereoscopic image are overlapped with each other, by using the depth map of the stereoscopic image. If the stereoscopic image includes only both the left-eye image and the right-eye image, the electronic device may generate a depth map by using the stereoscopic image.

According to an embodiment, if there is not identified an object, the display location of which overlaps the display location of the UI and the depth value of which is less than the depth value of the UI, in step 1060, the electronic device may display the UI and the stereoscopic image in the display. For example, the electronic device may display the UI corresponding to the UI display event in the display depending on the display location and the depth value set in UI.

According to an embodiment, if there is identified the object, the display location of which overlaps the display location of the UI and the depth value of which is less than the depth value of the UI, in step 1040, the electronic device may change the depth value of at least one of the UI and the identified object. For example, the electronic device may decrease the depth value of the UI so as to be less than the depth value of the identified object. For another example, the electronic device may increase the depth value of the identified object such that the depth value of the UI is less than the depth value of the identified object. For another example, the electronic device may increase the depth value of the UI so as to be greater than the depth value of the identified object. For another example, the electronic device may decrease the depth value of the identified object such that the depth value of the UI is greater than the depth value of the identified object.

According to an embodiment, when changing the depth value of the UI or the identified object, the electronic device may change the size of the UI or the identified object in 3D space. The electronic device may change the size of the UI or the identified object based on the depth value of the UI or the identified object, i.e., to be proportional to the depth value of the UI or the identified object.

According to an embodiment, in step 1050, the electronic device may change an overlap order of a layer including the UI and a layer including the identified object so as to correspond to the changed depth value. In the case where the display locations and the depth values of the UI and the identified object are the same as each other, step 1050 may be skipped.

According to an embodiment, in step 1060, the electronic device may display the UI and the stereoscopic image in the display. For example, if at least one of the depth values, the overlap order, and the sizes of the UI and the identified object is changed, the electronic device may display the UI and the stereoscopic image in the display depending on the changed depth values, overlap order, and sizes. If the depth value of the UI or the identified object is less than a specified depth value, the electronic device may display the stereoscopic image and the UI as a 2-dimensional (2D) image.

According to an embodiment, in step 1070, the electronic device may determine whether at least one object included in the stereoscopic image or the UI is changed. For example, the electronic device may determine whether the display location or the depth value of the at least one object included in the stereoscopic image or the UI is changed.

According to an embodiment, if the at least one object included in the stereoscopic image or the UI is changed, the electronic device may perform step 1030 to step 1060 again.

The term “module” used in this disclosure may indicate a unit including one or more combinations of hardware, software and firmware. The term “module” may be interchangeably used with the terms “unit”, “logic”, “logical block”, “component”, and “circuit”, may be a minimum unit of an integrated component or may be an integrally configured part, may be a minimum unit for performing one or more functions, and may be implemented mechanically or electronically. For example, the “module” may include at least one of an application-specific IC (ASIC) chip, a field-programmable gate array (FPGA), and a programmable-logic device for performing some operations, which is known or will be developed.

At least a part of an apparatus or a method according to embodiments of the present disclosure may be implemented by instructions stored in a computer-readable storage media in the form of a program module. The instruction, when executed by a processor, may cause the one or more processors to perform a function corresponding to the instruction.

A computer-readable recording medium may include a hard disk, a floppy disk, a magnetic media, such as a magnetic tape, an optical media, such as a compact disc read only memory (CD-ROM) and a digital versatile disc (DVD), a magneto-optical media, such as a floptical disk, and hardware devices, such as a read only memory (ROM), a random access memory (RAM), or a flash memory. The program instruction may include not only a mechanical code such as things generated by a compiler but also a high-level language code executable on a computer using an interpreter. The above hardware unit may be configured to operate via one or more software modules for performing an operation and vice versa.

A module or a program module according to embodiments may include at least one of the above elements, or a part of the above elements may be omitted, or additional other elements may be further included. Operations performed by a module, a program module, or other elements may be executed sequentially, in parallel, repeatedly, or in a heuristic method. In addition, some operations may be executed in different sequences or may be omitted. Alternatively, other operations may be added.

While the present disclosure has been shown and described with reference to embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display; and
a processor configured to:
display a stereoscopic image including one or more objects in the display;
if an event in which a user interface (UI) is displayed occurs, identify an object, a display location of which overlaps a display location of the UI and a depth value of which is less than a depth value of the UI, from among the one or more objects;
change the depth value of at least one of the UI and the identified object; and
display the UI and the stereoscopic image in the display depending on the changed depth value.

2. The electronic device of claim 1, wherein the processor is further configured to identify an object, a depth value of at least part of which is less than the depth value of the UI, as an object, a depth value of which is less than the depth value of the UI.

3. The electronic device of claim 2, wherein the processor is further configured to identify display locations and depth values of the one or more objects included in the stereoscopic image based on a depth map included in the stereoscopic image.

4. The electronic device of claim 3, wherein the processor is further configured to: if the depth map is not included in the stereoscopic image, generate the depth map by using the stereoscopic image; and
identify the display locations and the depth values of the one or more objects included in the stereoscopic image based on the generated depth map.

5. The electronic device of claim 1, wherein the processor is further configured to decrease the depth value of the UI such that the depth value of the UI is less than the depth value of the identified object.

6. The electronic device of claim 5, wherein the processor is further configured to change a size of the UI or the identified object so as to correspond to the changed depth value.

7. The electronic device of claim 1, wherein the processor is further configured to increase the depth value of the identified object such that the depth value of the UI is less than the depth value of the identified object.

8. The electronic device of claim 1, wherein the processor is further configured to increase the depth value of the UI such that the depth value of the UI is greater than the depth value of the identified object.

9. The electronic device of claim 8, wherein the processor is further configured to change an overlap order of a layer including the UI and a layer including the identified object so as to correspond to the changed depth value.

10. The electronic device of claim 1, wherein the processor is further configured to decrease the depth value of the identified object such that the depth value of the UI is greater than the depth value of the identified object.

11. The electronic device of claim 1, wherein the processor is further configured to, if the changed depth value of the UI is less than a specified depth value, display the stereoscopic image and the UI as a 2-dimensional (2D) image.

12. The electronic device of claim 1, wherein the processor is further configured to, if display locations and depth values of the one or more objects included in the stereoscopic image is changed, change the depth value of at least one of the UI and the identified object depending on the changed display locations or the changed depth values of the one or more objects.

13. A displaying method of an electronic device, the method comprising:
displaying a stereoscopic image including one or more objects in a display;
if an event in which a UI is displayed occurs, identifying an object, a display location of which overlaps a display location of the UI and a depth value of which is less than a depth value of the UI, from among the one or more objects;
changing the depth value of at least one of the UI and the identified object; and
displaying the UI and the stereoscopic image in the display depending on the changed depth value.

14. The method of claim 13, wherein identifying the object, the display location of which overlaps the display location of the UI and the depth value of which is less than the depth value of the UI, from among the one or more objects includes identifying an object, a depth value of at least part of which is less than the depth value of the UI, as an object, a depth value of which is less than the depth value of the UI.

15. The method of claim 13, wherein changing the depth value includes decreasing the depth value of the UI such that the depth value of the UI is less than the depth value of the identified object.

16. The method of claim 15, further comprising:
changing a size of the UI or the identified object so as to correspond to the changed depth value.

17. The method of claim 13, wherein changing the depth value includes increasing the depth value of the identified object such that the depth value of the UI is less than the depth value of the identified object.

18. The method of claim 13, wherein changing the depth value includes increasing the depth value of the UI such that the depth value of the UI is greater than the depth value of the identified object.

19. The method of claim 18, further comprising:
changing an overlap order of a layer including the UI and a layer including the identified object so as to correspond to the changed depth value.

20. The method of claim 13, wherein changing the depth value includes decreasing the depth value of the identified object such that the depth value of the UI is greater than the depth value of the identified object.
